(19) United States
(12) Patent Application Publication
(10) Pub. No.: US 2011/0266217 A1
(43) Pub. Date: Nov. 3, 2011

(54) METHOD FOR CLEANING FILTER SEPARATION SYSTEMS

(75) Inventors: Ralph J. Kajdasz, Huntington Beach, CA (US); Sidney Dunn, Lake Charles, LA (US)

(73) Assignee: BAKER HUGHES INCORPORATED, HOUSTON, TX (US)

(21) Appl. No.: 13/089,900

(22) Filed: Apr. 19, 2011

Related U.S. Application Data
(60) Provisional application No. 61/328,737, filed on Apr. 28, 2010.

(51) Int. Cl. B01D 65/02

(52) U.S. Cl. 210/636

(57) ABSTRACT

High shear separations of suspensions and colloid suspensions may be preformed using a fouling reduction agent to optimize the separations. The fouling reduction agents are solids. Exemplary of such solids are powdered cellulose, clays, diatomaceous earth and the like. Process streams which may treated include refinery process waste water, chemical process waste water, food processing waste water, power generation waste water, chemical product streams, and chemical intermediate streams.

### CROSS-REFERENCE TO RELATED APPLICATIONS

This application claims priority from U.S. Provisional Application Ser. No. 61/328,737, filed Apr. 28, 2010, the disclosure of which is incorporated herein by reference in its entirety.

### BACKGROUND

1. Field of the Disclosure

The invention relates to the separation of solids from a liquid using a filter separation method and methods of reducing fouling thereof. The invention particularly relates to enhancements to a method for reducing fouling of a high shear filter separation system.

2. Background of the Disclosure

Where fluids are contaminated with undesirable solids or where desirable solids are suspended in fluids, separation devices are typically utilized to separate the solids from the fluid. There are a wide variety of different separation methods. Exemplary methods include but are not limited to microfiltration, ultrafiltration, nanofiltration, reverse osmosis (hyperfiltration), dialysis, electrodialysis, prevaporation, water splitting, sieving, affinity separation, affinity purification, affinity sorption, chromatography, gel filtration, bacteriological filtration, and coalescence. Exemplary separation devices include, but are not limited to dead end filters, open end filters, cross-flow filters, dynamic filters, vibratory separation filters, disposable filters, regenerable filters including back-washable filters, blowback filters, solvent cleanable filters, and hybrid filters.

A common problem in virtually all separation systems having a filter is fouling of the filter. Permeate passing through the filter from the upstream side to the downstream side of the filter leaves a retentate layer adjacent to the upstream side of the filter having a different composition than that of the process fluid. This retentate layer may include components which bind to the filter and clog its pores, thereby fouling the filter, or may remain as a stagnant boundary layer, either of which hinders transport of the components trying to pass through the filter to the downstream side of the filter. In essence, mass transport through the filter per unit time, i.e., flux, may be reduced and the inherent sieving or trapping capability of the filter may be adversely affected.

One solution to this problem is to use separation systems which create high shear rates at the surface of a filter to mitigate and/or delay fouling thereby increasing filter life. One application that meets these criteria is the use of the so called “Vibratory Dynamic Filter Systems” in which filter discs are oscillated at predetermined frequencies. The Vibratory Dynamic Filter Systems are disclosed in. U.S. Pat. No. 4,526,688. In this reference, a shock-type system is disclosed where the membrane support structure and a filtration apparatus are periodically impacted to induce the filter cake to drop from the filter. Other variations of these systems can be found in: U.S. Pat. Nos. 4,545,969; 3,970,564; and 4,253,962.

Another system useful with the invention are the so called VSEP systems available from New Logic Research, Inc. The VSEP devices include those such are disclosed in U.S. Pat. No. 4,952,317. Therein are disclosed devices for separating selected components from a colloidal suspension utilizing a vessel capable of holding the colloidal suspension. A membrane permeable to selected components of a colloidal suspension is sealed over a support to form a leaf element. The leaf element includes an outlet for the selected components of the colloidal suspension and is extended into the colloidal suspension. The leaf element is controllably vibrated and simultaneously with application of a negative or positive pressure which is used to motivate permeation of the membrane by selected components of the colloidal suspension.

More recently, Pall Corporation has disclosed a vibratory separation system having a drive mechanism for imparting a vibratory motion to a membrane module to enhance filtration. The membrane module comprises one or more filter elements secured to one another, each having a permeable membrane. The vibratory motion imparted to the membrane module generates a dynamic flow boundary layer at the permeable membranes. This fluid shear boundary layer, in turn, generates lift, thereby inhibiting fouling of the membranes. This type of system is disclosed in U.S. Pat. No. 6,322,698 and WO 99/36150.

### SUMMARY

In one aspect, the invention is a method for enhancing filtration through a filter separation system including introducing a fouling reduction agent into a cleaning fluid to produce a treated cleaning fluid and then passing the treated cleaning fluid through the filter separation system, wherein the fouling reduction agent is a solid. In some embodiments, the solid is selected from the group consisting of powdered cellulose, powdered clays, diatomaceous earth, silica, alumina, calcium carbonate, and perlite. In other embodiments, the membrane separation system is used for reverse osmosis, nano-filtration, and ultra-filtration. In still other embodiments, the filter separation system is a membrane type high shear system such as a VSEP® system.

### BRIEF DESCRIPTION OF THE FIGURES

For a detailed understanding of the present invention, reference should be made to the following detailed description, taken in conjunction with the accompanying figures wherein:

FIGS. 1-4 are graphs showing percent flux rate changes measured in Example 1; and

FIGS. 5-8 are photographs illustrating the effectiveness of the fouling reduction agents tested in Example 2.

### DESCRIPTION

In one aspect, the invention may be a method for enhancing filtration through a high shear separation system. For the purposes of this application, the term “separation” shall be understood to include all methods, including filtration, wherein one or more components of a fluid is or are separated from the other components of the fluid. The term “filter” shall be understood to include any medium made of any material that allows one or more components of a fluid to pass therethrough in order to separate those components from the other components of the fluid. The fluid which is input to the separation system shall be referred to as “process fluid” and construed to include any fluid undergoing separation. The portion of the fluid which passes through the separation medium shall be referred to as “permeate” and construed to include filtrate as well as other materials. The portion of the fluid which does not pass through the separation medium shall be referred to as “retentate.”

In some embodiments, the method of the disclosure includes passing the treated fluid through a high shear separation system. For the purposes of this application, a high shear separation system is any separation system that uses shear energy at the surface of a filter to reduce fouling. The shear energy may be introduced in any way known to those of ordinary skill in the art of performing separations to be useful. For example, the method of the disclosure may be used with any Vibratory Dynamic Filter System. In another embodiment, the method may be used with the VSEP® system which is available from New Logic Research, Inc. In still another embodiment, the method may be used with the vibratory separation systems of the Pall Corporation.

In at least one embodiment of the disclosure, the high shear separation system includes a filter. The filter can be any known to be useful to those of ordinary skill in the art of effecting separations, but in some embodiments, the filter is a membrane. As used herein, “membrane” shall mean a porous medium wherein the structure is a single continuous solid phase with a continuous pore structure. Depending upon the pore size and other aspects of the membrane, such membranes may be use for micro- and nano- filtrations. Membranes with a pore size of 0.1-10 μm are typically used to perform micro filtrations. Membranes that can exclude particles 0.001-0.1 μm in diameter are typically used to perform nano-filtrations. Nano-filtrations are sometimes referenced to in the art as ultra-filtrations. Other applications include ultra-filtrations and reverse osmosis filtrations

The process fluids that can be used with the method of the disclosure are any that can be effectively separated using a high shear separation system. In one embodiment, the process fluid is a suspension where a component of interest is suspended in a fluid. In another embodiment, the process fluid is a colloid wherein a component of interest is suspended in a fluid as a colloid suspension. For the purposes of the present invention, a colloid suspension is one wherein solids having a particle diameter of from about 1 to about 100 nanometers are suspended in a fluid. These fluids tend to have properties that are intermediate between suspensions and solutions.

In another embodiment of the disclosure, the process of the disclosure may be used to remove undesirable dissolved materials from solution. While not wishing to be limited to any particular theory or mechanism, it is believed that in some instances, certain materials can be precipitated as they approach a filter and in other instances, the dissolved materials that would otherwise interact with a membrane and foul it may be adsorbed by pin flock or other materials collecting at or arising at the filter.

The fouling reduction agents useful with some embodiments of the method of the disclosure include powdered cellulose, powdered clays, diatomaceous earth, silica, alumina, calcium carbonate, and perlite. Cellulose is a polysaccharide commonly found in the cell wall of plants and bacteria. Any powdered cellulose known to be useful to those of ordinary skill in the art may be used with the method of the disclosure. In some embodiments, the cellulose may be obtained from wood pulp and cotton. In other embodiments, the cellulose may be microcrystalline cellulose obtained by decomposing wood pulp.

Powdered clays useful with the method of the disclosure also include any known to be useful to those of ordinary skill in the art. For example, in some embodiments, the powdered clay may be selected from natural or synthetic chrome-free clays selected from the group consisting of sepiolite, laponite, hectorite, attapulgite, montmorillonite, and combinations thereof. The powered clay may be a simple bentonite mixture or a complex clay such as those listed above. For example, sepiolite is a complex magnesium silicate clay mineral; hectorite is a silicate clay mineral; laponite clay is a synthetic version of hectorite; attapulgite is a magnesium aluminum phyllosilicate clay; and montmorillonite is a phyllosilicate mineral, and includes bentonite clay.

Diatomaceous earth, silica, alumina, and calcium carbonate are well known to those of ordinary skill in the art of making slurries. Perlite is a natural volcanic glass which may be useful in some applications of the method of disclosure. These compounds may be used in any form that allows the compounds to be introduced into a process fluid.

The fouling reduction agents may be used in any concentration that is effective for increasing membrane life and improving separations. The makeup of the cleaning fluid being treated with the fouling agent will, in some applications, dictate the concentration of the fouling reduction agents. One means of determining effective concentration levels for the fouling reduction agents is known as a jar test. In a jar test, a preselected volume of process fluid is placed into one or more containers. Exemplary containers include jars, beakers and cylinders. Each container is dosed with a known amount of fouling reduction agent and then observed for a predetermined period of time. Based upon observations of the “jars,” a trial dosage may be selected and used in a separation system. Further changes may be made in order to optimize dosage levels.

In some embodiments of the disclosure, the fouling reduction agent concentration in a process fluid will be from 0.5 to 5 percent (weight to volume). In other application, the concentration will be from 1 to 4 percent. In still other applications, the concentration will be from 1.5 to 2.5 percent. Those of ordinary skill in the art of treating water will well know the principles and practices of selecting and optimizing dosages of additives and agents such as the fouling reduction agents of the present invention.

The fouling reduction agents may be introduced into a cleaning fluid, often just the normal process fluid using any method known to be useful to those of ordinary skill in the art. If introduced as a solid, then the treated cleaning fluid will be desirably agitated to ensure dispersal of the fouling reduction agent, in some embodiments first forming a slurry with the cleaning fluid. If the fouling reduction agent is introduced as a slurry, less mixing and agitation may be required.

In one embodiment of the disclosure, the fouling reduction agent will have a residence time within the cleaning fluid prior to filtration of at least 30 seconds. In another embodiment of the disclosure, the fouling reduction agent will have a residence time within the cleaning fluid of at least 5 minutes. In still another embodiment, the fouling reduction agent will have a residence time within the cleaning fluid of at least 30 minutes.

The fouling reduction agents may be introduced and admixed with the cleaning fluid to produce a treated cleaning fluid in any way known to be useful to those of ordinary skill in the art of admixing fluids with solids and other fluids. For example, the fouling reduction agents may be pumped into a pipe carrying process fluid and having therein a static mixer. In another embodiment, a process fluid may be passed through a holding tank which includes a powered mixer and the fouling reduction agents may be added to the process fluid at this point. In an alternative embodiment, the cleaning fluid is not a process fluid but is otherwise treated the same as described immediately above.

The method of the disclosure is useful with any process fluid having a separable solid component. Exemplary process fluids include, but are not limited to: refinery process waste water, chemical process waste water, raw water clarifier streams, industrial laundry streams, pulp and paper processes, municipal waste water, municipal raw water, boiler and cooling tower blow down, food processing waste water, power generation waste water, chemical process streams, refinery process streams, and chemical intermediate streams.

The method of the disclosure may be used with high shear filtration processes to optimize the processes. For example, in one embodiment, the fouling reduction agents may be used to increase flux through a filter. In another embodiment, the fouling reduction agents may be used to extend filter life which can reduce down time and increase productivity. Either or both of these improvements can result in power savings, waste volume reduction, increase recycling of waste water, improved process yields, production process de-bottlenecking; and the like which can ultimately result in economic yield improvements to processes incorporating the method of the disclosure.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

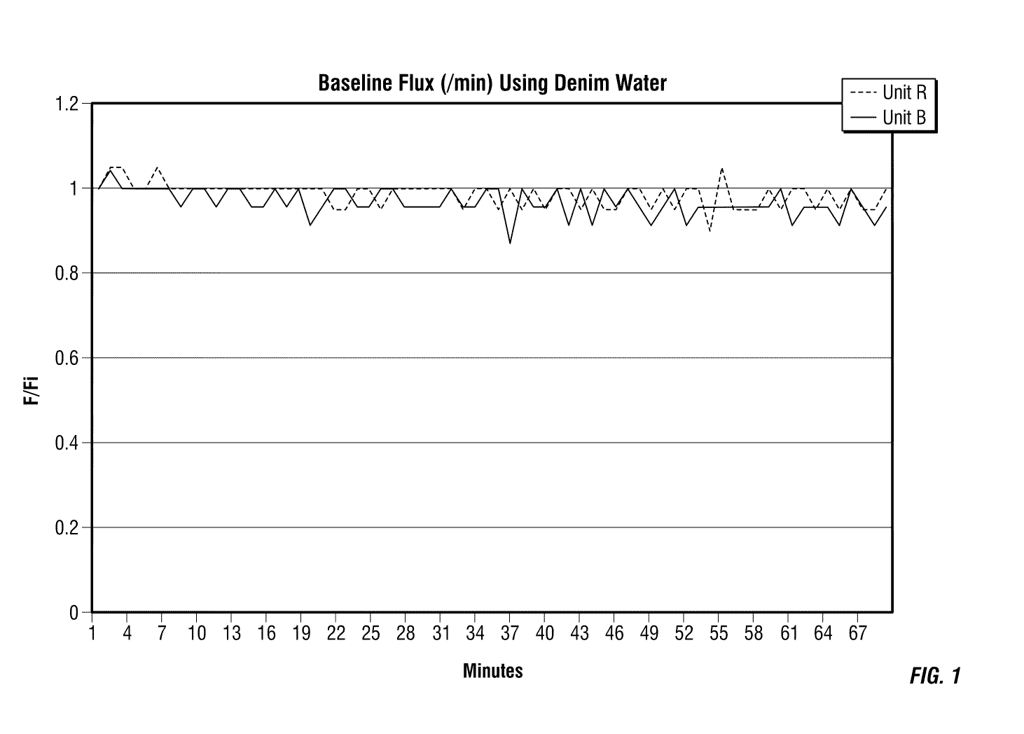

2 membrane separation system were tested using demineralized water at 500 PSI and at 122° F. The flux rate through both units was determined and the result are shown in FIG. 1. Note that both unites were operating essentially identically after the demineralized water test.

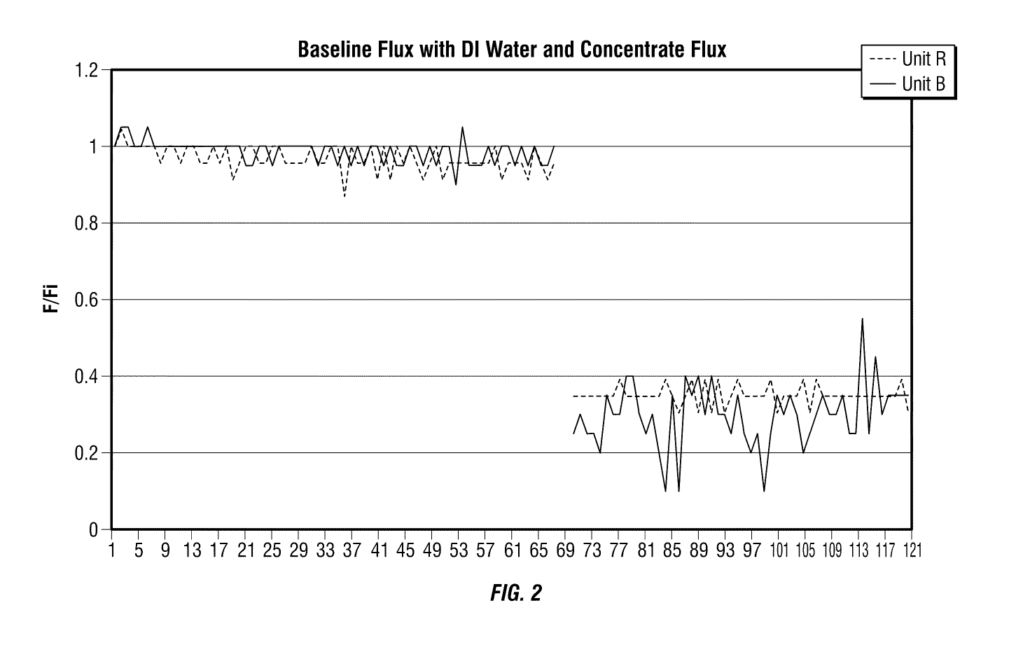

Then concentrated solids feed without the normal addition of surfactant and chelant was introduced into both units. The surfactant and chelant tend to reduce the amount of foulant on the membrane. In this test, fouling was maximized to increase the foulant deposited on the membrane. After 96 hours of concentration, the flux for both units was determined and displayed in FIG. 2. The graph below shows the change in flux from a clean membrane using demineralized water to a fouled membrane using concentrate solids feed. Note that the reduction in flux for both systems is essentially the same.

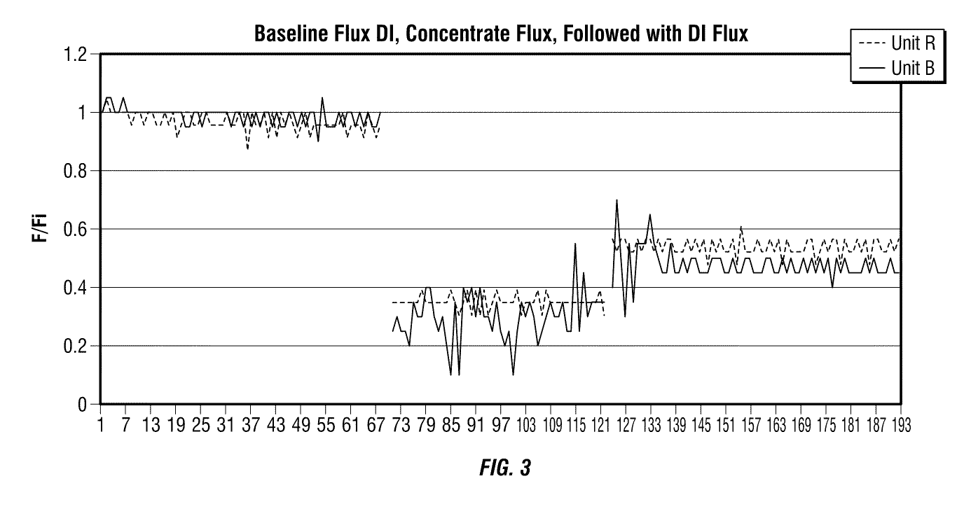

Both units were rinsed, filled with deionized water and the flux was retested. In FIG. 3, the data from the retest shows that both systems had recovered some flux rate.

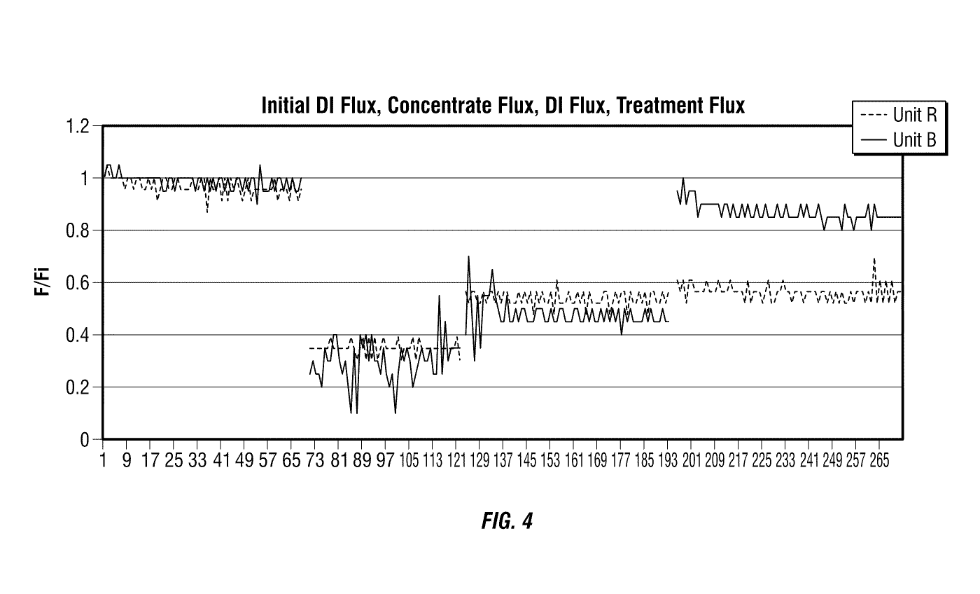

Unit A was treated with demineralized water. Unit B was treated with a solution/slurry of 0.5% bentonite and 0.5% diatomaceous earth. Both unite were so treated for 1 hour. Then both units were washed in a manner similar to that of a commercial unit: (1) both units were treated with a 3% solution of Guardion 505 (an alkaline surfactant cleaner) for 1 hour, (2) the units were then rinsed with demineralized water, and (3) then both units were treated with a 3% solution of Guardion 404 (a citric acid solution) for 1 hour. After treatment, a DI flux was run on both units. The results of the flux test are shown in FIG. 4 which shows that while Unit A showed a slight improvement in flux after the cleaning, Unit B significantly surpassed Unit A in flux rate showing the clear effectiveness of a solid based cleaner.

### Example 2

Heavily and identically fouled membranes were cleaned using different solids. All membranes were prepared by filtering a high solids feed with no surfactant or chelant for 72 hours. Various 1% suspensions were tested. The suspensions were added to the test apparatus and allowed to mix for 16 hours.

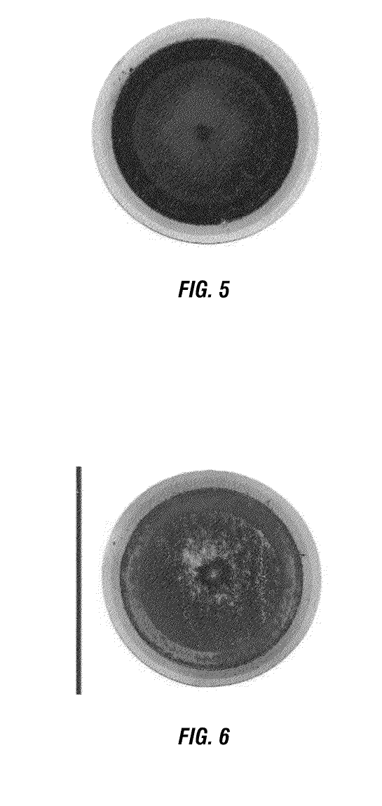

FIG. 5 shows a membrane treated with a 1% concentration of powdered calcium carbonate. Some foulant has been removed and this test is used as a baseline to indicate that the agent is effective.

FIG. 6 shows a membrane treated with a 1% suspension of bentonite. Note that more of the deposit has been removed.

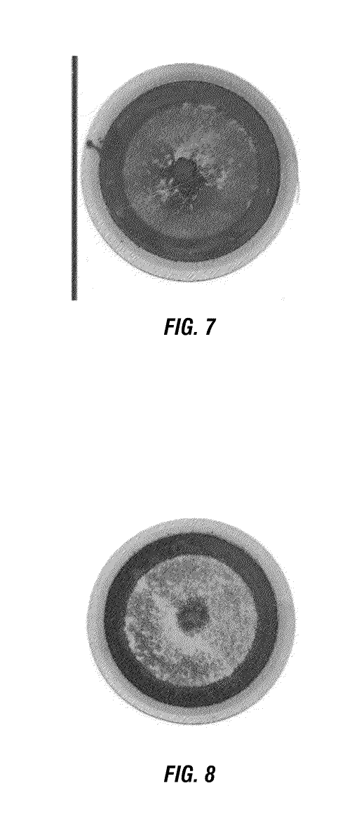

FIG. 7 shows a membrane treated with a suspension of an admixture (0.5%) of bentonite and (0.5%) diatomaceous earth. Note that even more of the deposit has been removed.

FIG. 8 shows a membrane treated with a 1% suspension of powdered cellulose. Note that this composition resulted in the most deposit having been removed.

1. A method for enhancing filtration through a filter separation system comprising introducing a fouling reduction agent into a cleaning fluid to produce a treated cleaning fluid and then passing the treated cleaning fluid through the filter separation system, wherein the fouling reduction agent is a solid.

2. The method of claim 1 wherein the solid is selected from the group consisting of powdered cellulose, powdered clays, diatomaceous earth, silica, alumina, calcium carbonate, perlite, and combinations thereof.

3. The method of claim 2 wherein the solid is powdered cellulose obtained from wood pulp or cotton.

4. The method of claim 2 wherein the solid is powdered cellulose that is a microcrystalline cellulose obtained by decomposing wood pulp.

5. The method of claim 2 wherein the solid is a powdered clay.

6. The method of claim 5 wherein the powdered clay is a bentonite mixture.

7. The method of claim 5 wherein the powdered clay is selected from the group consisting of sepiolite, laponite, hectorite, attapulgite, montmorillonite, and combinations thereof.

8. The method of claim 1 wherein the fouling reduction agent concentration in the cleaning fluid is from about 0.5 to about 5 percent (weight to volume).

9. The method of claim 8 wherein the fouling reduction agent concentration in the cleaning fluid is from about 1 to about 4 percent (weight to volume).

10. The method of claim 9 wherein the fouling reduction agent concentration in the cleaning fluid is from about 1.5 to about 2.5 percent (weight to volume).

11. The method of claim 1 wherein the fouling reduction agent has a residence time within the cleaning fluid prior to filtration of at least 30 seconds.

12. The method of claim 1 wherein the fouling reduction agent has a residence time within the cleaning fluid prior to filtration of at least 5 minutes.

13. The method of claim 1 wherein the fouling reduction agent has a residence time within the cleaning fluid prior to filtration of at least 30 minutes.

14. The method of claim 1 wherein the cleaning fluid is prepared using a process stream.

15. The method of claim 1 wherein the cleaning fluid is admixed with the fouling reduction agent and agitated to disperse the fouling reduction agent within the cleaning fluid.

16. The method of claim 15 wherein the fouling reduction agent is first prepared as a slurry.

17. The method of claim 1 wherein the separation system is used to treat a process stream selected from the group consisting of refinery process waste water, chemical process waste water, raw water clarifier streams, industrial laundry streams, pulp and paper processes, municipal waste water, municipal raw water, boiler and cooling tower blow down, food processing waste water, power generation waste water, chemical process streams, refinery process streams, chemical intermediate streams, and combinations thereof.

18. The method of claim 1 wherein the filter separation system is a membrane separation system.

19. The method of claim 18 wherein the membrane separation system is used for a process selected from the group consisting of reverse osmosis, nano-filtration, and ultra-filtration.

20. The method of claim 18 wherein the membrane separation system is a membrane type high shear system.
